(19) United States
(12) Patent Application Publication
(10) Pub. No.: US 2006/0278729 A1
(43) Pub. Date: Dec. 14, 2006

(54) Apparatus and methods for locating underground system components

(76) Inventor: Lee Humrickhouse, Frankfort, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/133,873

(22) Filed: May 20, 2005

(51) Int. Cl. B67D 5/08

(52) U.S. Cl. 239/73; 239/1

(57) ABSTRACT

A system, device, and method for locating the position of underground components of a system using rising structures. The rising structures have indicia which indicate the location of various components of the system.

### TECHNICAL FIELD

Apparatus and methods for locating underground components of a system, more particularly, but not exclusively, to apparatus and methods for locating underground sprinkler systems.

### BACKGROUND

Many different kinds of systems for the flowed delivery of water, natural gas, oil, electricity, electrical or data signals, and/or other fluids, energy, and/or data are often buried under the ground. Discussed herein are various apparatus and methods for locating various components of any and/or all such systems.

One example of such an underground system is a water sprinkler system which is commonly used to irrigate residential and commercial real estate. Many times these sprinkler systems are placed underground during the construction of houses or other structures upon the land. Other times they are installed after the original construction. These sprinkler systems may include sprinkler heads that permanently rise above the ground or pop out of the ground once water pressure is applied. In addition, boxes containing one or more controls may become covered, over time, by dirt, grass, or other growth hiding their location. For a variety of reasons, known to the art, the location of various system components must be determined. In such circumstances, the original installation map could be referenced if available. Alternatively, the ground could be dug up.

### SUMMARY

The following is not intended to alter the scope of the claims in any way. Any use of this section to alter the scope of the invention as defined in the claims is improper and is not the intention of the drafter. One is directed to the claims at the end of this document; those claims summarize the various claimed inventions.

### BRIEF DESCRIPTION OF THE DRAWINGS

FIG. 1 illustrates a schematic drawing of the underground system component locating system according to an example embodiment.

FIG. 2 is a side elevational schematic view of a portion of a system to locate components of an underground system.

FIG. 3 is an exploded view of a sprinkler head according to an example embodiment.

FIG. 4 is a side elevational view of an example embodiment of a riser that could be used with the sprinkler head of FIG. 3.

FIG. 4A is a bottom elevational view of the riser illustrated in FIG. 4.

FIG. 4B is a cross sectional view of the riser illustrated in FIG. 4.

FIG. 5 is a side elevational view of another example embodiment of a riser according to the embodiment of a sprinkler head as illustrated in FIG. 3.

FIG. 5A is a bottom elevational view of the riser illustrated in FIG. 5.

FIG. 5B is a cross sectional view of the riser illustrated in FIG. 5.

FIG. 6 is a side elevational view of another example embodiment of a riser according to the embodiment of a sprinkler head as illustrated in FIG. 3.

FIG. 6A is a bottom elevational view of the riser illustrated in FIG. 6.

FIG. 6B is a cross sectional view of the riser illustrated in FIG. 6.

FIG. 7A-7I illustrates different indicia for use on the top surface of the riser illustrated in the sprinkler head of FIG. 3.

FIG. 8 illustrates a block diagram of a method for installing an example embodiment.

### DETAILED DESCRIPTION

For the purposes of promoting an understanding of the principles of my apparatus and methods, reference will now be made to selected embodiments and specific language will be used to describe the same. It will nevertheless be understood that no limitation of the scope of the claims of the invention is thereby intended. Any alterations, modifications, and further applications of the principles of my apparatus and methods as illustrated being contemplated as would normally occur to one skilled in this art.

Apparatus and methods for locating underground components of a system are described. These embodiments are examples. My apparatus and methods will serve to locate components of a variety of underground systems used for utility or data such as water, natural gas, oil, electricity, cable, electronic data transmission and the like. I have chosen a water sprinkler system as an example to illustrate my apparatus and methods. In most embodiments, the system is an underground network of pipes and sprinkler heads to irrigate an area of real estate. The sprinkler heads are of the “pop-up” variety and begin spraying water to the areas of real estate upon the application of water pressure to the sprinkler heads through the pipes. Most embodiments contemplate removing one or more or a portion of these sprinkler heads and replacing them with a rising structure that has indicia placed upon it to locate the position of the underground pipes and/or valve boxes located in the underground system. These rising structures may operate on the same principle as the rising part of the sprinkler head.

Alternatively, a separate line for the rising structures with indicia can be used so that they can rise separate from the sprinkler heads. For example, in some embodiments, a separate pneumatic line can be connected to all the rising structures having its own valve so that activation of the valve results in the rising of the rising structures. Further, each of the rising structures could have their own solenoid or other actuator to cause them to rise. It is to be appreciated by those skilled in the art that the foregoing description was only very general and the following description will be more specific and discuss some various embodiments and ways of practicing my apparatus and methods.

The rising structures can move through a variety of positions substantially vertical to the plane of the ground. These positions can be grouped into two major classes. The first position group is labeled lower positions because when the rising structure occupies one of these positions the indicia is not necessarily visible to persons walking upon the ground. In a lower position the indicia on the rising structure may be either fully or partially hidden from view. For instance, when the entire rising structure lies beneath the plane of the ground this can be one lower position. In some embodiments, when the very top of the rising structure is slightly below or substantially level with the plane of the ground, but nevertheless not easily visible due to the ground features or vegetations, this can be a lower position. Those skilled in the art recognize that lower positions can occur in various ranges of vertical positions.

The second position group is labeled upper positions because when the rising structure occupies one of these positions the indicia is more readily visible to persons walking upon the ground. An example would be when a portion of the rising structure has extending above the plane of the ground. Alternatively, an upper position would occur in some embodiments when the top of the rising structure is slightly below or substantially level with the plane of the ground. Those skilled in the art recognize that the range of vertical positions that are lower positions or upper positions varies for differing embodiments. For example, what would be a lower position in one embodiment could be an upper position in another embodiment. Somewhere along the range of vertical positions that the rising structure occupies in operation the transformation from a lower position to an upper position is effectuated. In other words, in a lower position the indicia is hidden and/or less easily seen and in the upper position it is easily seen.

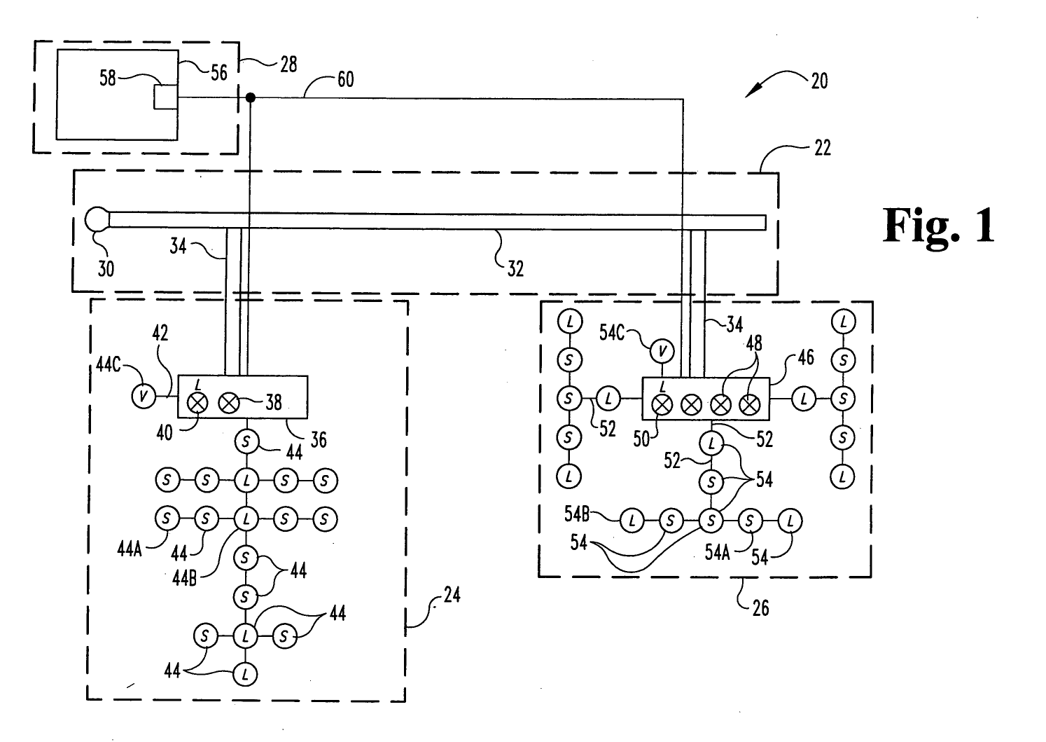

Referring now to the drawings, FIG. 1 illustrates an irrigation system 20. Those skilled in the art, however, will readily recognize that any underground system having underground components to be located can be an alternative embodiment. Limitation to the irrigation system 20 is not intended. Irrigation system 20 comprises four main parts. The first part is a supply system 22. The supply system 22 provides water to the irrigation system for spraying across the real estate that the irrigation system 20 lies beneath. In some embodiments, the supply system 22 could provide air, a water/fertilizer mix or any other type of fluid readily apparent to those skilled in the art. The second section of the irrigation system 20 is the first distribution system 24. The first distribution system 24 is a series of components that extends the fluid over a wide surface area to the real estate above. The first distribution system 24 is operatively coupled to the supply system 22 so that the supply system 22 can provide the fluid that will be distributed through the first distribution system 24. The third part of the irrigation system 20 is the second distribution system 26. The second distribution system 26 operates very similarly to the first distribution system 24. The second distribution system 26 assists in spreading the fluid provided by the supply system 22 over a larger area of real estate. While in FIG. 1 only two distribution systems 24 and 26 are illustrated, it is contemplated that other embodiments include any number of distribution systems appropriate for the designer. The irrigation system 20 illustrated in FIG. 1 also includes an electrical system 28. In some embodiments, no electrical system is used. The electrical system 28 is operatively coupled to the first distribution system 24 and the second distribution system 26. The electrical system 28 allows a user to remotely control the operation of the first distribution system 24 and/or the second distribution system 26 through electrical means.

The supply system 22 includes three more distinct parts. The first part is the water main 30. The water main 30 is connected to a main line (not shown) that connects to a water tower (not shown) or other acquifer in the surrounding area to provide the source of water at a certain pressure. Those skilled in the art, will recognize that similar fluid-type systems having a similar design could be utilized in other embodiments. The water main 30 is connected to a main pipe 32. The main pipe 32 could be considered the back bone of the irrigation system 26. Water is provided in a central way to all the different distribution systems 24 and 26 that exist across the real estate to be treated. The main pipe 32 also includes branching pipes 34 which operatively couple to the distribution systems 24 and 26 in order to provide the distribution systems with a pressurized supply of water.

The first distribution system 24 includes a first valve box 36. It is understood that other types of boxes containing various types of controls are also included. The first valve box 36 is any type of container that is suitable for insertion into the ground and contains valves 38 to control the feed of water to the smaller and more specifically designed distribution sections. Valves 38 can be any type of valve readily apparent to those skilled in the art, such as check valves, butterfly valves, ball valves or the like. The first valve box 36 also includes a locator valve 40 in the embodiment illustrated in FIG. 1. In some embodiments, a locator valve is not used. In the illustrated embodiment, the locator valve 40 connects to a valve box locator sprinkler head as described herein below. The locator valve 40 could be connected to a pneumatic supply system (not shown) in alternate embodiments. Opening of the locator valve 40 enables fluid to actuate structures to locate the first valve box 36. Alternatively, the locator valve 40 can be used to control all of the locating sprinkler heads, instead of just the valve box locator. The first distribution system 24 also includes pipe 42. As illustrated in FIG. 1, the pipe 42 connects a plurality of sprinkler heads 44 in order to form a pattern of distribution across the real estate to be irrigated. Using the smaller connected pipe 42 and spreading the sprinkler heads 44 around, a large area of real estate can be irrigated. The sprinkler heads 44 come in three varieties as illustrated in FIG. 1. Those skilled in the art, however, recognize that many other varieties of sprinkler heads could be used in alternate embodiments. In addition, those skilled in the art will also recognize that alternate embodiments are not limited to simply sprinkler heads 44. Other types of structures can also be used. One type of sprinkler heads 44 are spray heads marked as S and labeled as 44A. Pipe locating heads are marked as L and labeled as 44B. Valve box locating heads are marked as V and are labeled as 44C. The spray heads 44A are normal sprinkler heads that enable the fluid that is being supplied by the supply system 22 to be sprayed above ground. The pipe locating heads 44B rise and indicate the location of the different underground pipes underneath the surface. The valve locating heads 44C locate the valve box position.

Referring now to the second distribution system 26, a similar situation is described. There is a second valve box 46 that contains the valves 48. A locator valve 50 is also utilized in the second valve box 46 in the illustrated embodiment. Pipes 52 connect all the sprinkler heads 54 and there are three different types of sprinkler heads 54A, 54B and 54C that designate that they are sprinkler heads, pipe locating heads or valve locating heads, respectively.

The electrical system 28 is used to provide electrical control of the operation of the first distribution system 24 and the second distribution system 26. The electrical system has a control room 56 that either can be a house, a residential garage, a section of a commercial building, a barn or any other structure readily apparent to those skilled in the art. Inside of the control room 56, there is a controller 58 that contains switches or the like that allow manual or even automatic control of the first distribution system 24 and the second distribution system 26. In some embodiments, the controller 58 is used simply to control the valves that control actuation of the locator heads 44B, 44C, 54B and 54C. In other embodiments, all the valves 38 and 48 can be controlled using the controller 58. Moreover, in some other embodiments, only the valves 38 besides the locator valves 40 are controlled. The controller 58 is operatively coupled to the valve boxes 36 and 46 using wires 60. These wires can be any type of insulated electrical coupling wire readily apparent to those skilled in the art. For example, but not limited to, optical cables, standard insulated copper wire, coaxial cable, or the like.

In operation, the irrigation system 20 of FIG. 1 works as follows. Water from the supply system 22 enters through the water main 30 through main pipe 32 and into the branching pipes 34 where they are closed from running into pipes 42 by the valves 38. An operator can be in control room 56 or the system can be automatic depending on the preferences of the designer. During operation, valves 38 are opened thereby allowing water to flow into pipes 42 which provides pressure to the sprinkler heads 44 causing them to rise. The spray heads 44A and 54A are designed so that water will spray out and irrigate the area surrounding it. The pipe locator heads 44B, 54B and the valve box locator heads 44C, 54C are designed simply to actuate and locate the position of the underground pipes 42 and valve boxes 36, 46. As explained before, the pipe locator and valve box locator heads can be on a separate circuit that is either hydraulically, electrically or pneumatically controlled or they can be combined with the sprinkler spray heads.

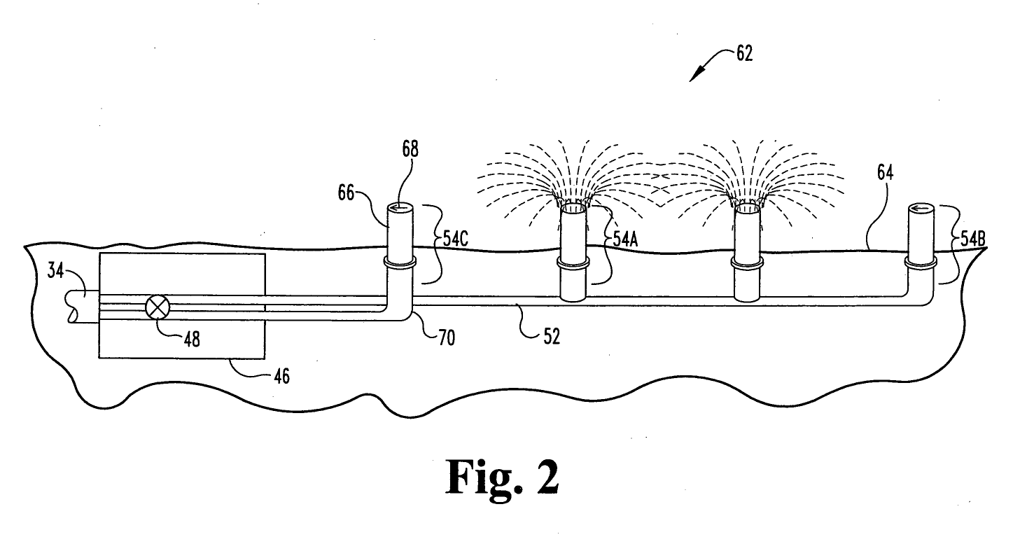

Referring now to FIG. 2 we see a distribution system portion 62. Distribution system portion 62 illustrates a branching pipe 34 feeding into the valve box 46 having the valve 48. Valve 48 controls the flow to the pipe 52 in a various amount of ways. For example, a separate valve 48 could be used for each section in pipe 52. The same valve could be used for all the sections of pipes that have multiple intake and output sections that are controllable. The pipes 42 are underneath the ground 64 and are hidden from view. FIG. 2 illustrates the distribution system portion 62 when water pressure has been applied through pipes 52. A common sprinkler spray head 54A illustrates that it is spraying water irrigating the land around it. A pipe locator head 54B locates the position of a section of underground pipes 52. A valve location head is labeled 54C. The valve location sprinkler head 54C is separated into three main portions. The first portion is a riser 66 that pops up when a certain amount of water pressure is applied. On top of the riser 66 is indicia 68 indicating the location of the second valve box 46. Attached to pipe 52 is the body 70 of the sprinkler head that contains and restrains the riser 66. Thus, when either pneumatic, hydraulic or electrical forces are applied to cause the riser 66 to rise some type of indicia 68 determines the location of either the pipe 52 or the valve box 46. FIG. 2 illustrates a riser 66 having an arrow on top of the riser 66 to point in the direction of the valve box 46. One option is to use different colors to indicate the different types of components. For example, the indicia 68 for a valve locating sprinkler head 54C may be purple where the color for a pipe locating sprinkler head 54B would be white. Of course it is apparent to those skilled in the art that many different types of indicia and many different types of color schemes could be used in a multitude of embodiments.

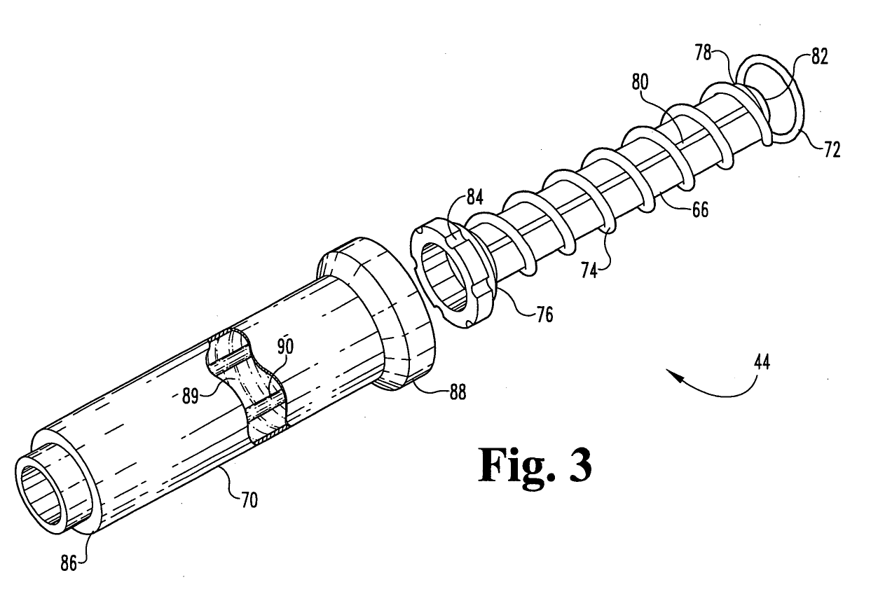

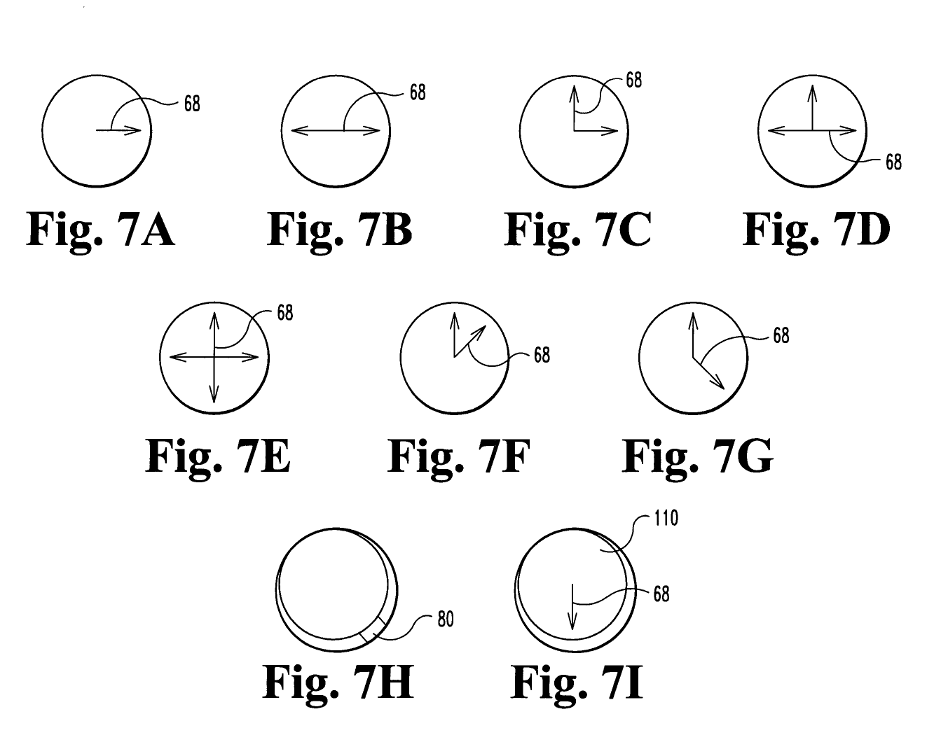

Referring now to FIG. 3, the sprinkler head 44 according to one embodiment is illustrated in more detail. The sprinkler head includes the riser 66 and the body 70. The body 70 receives the riser 66. The sprinkler head 44 also includes a cap 72 that passes over top of the riser and either screws on, snaps on or is integrally formed therewith of the body 70 in order to restrain the riser 66 from completely leaving the interior of the body 70. Surrounding the riser 66 is a spring 74 which urges the riser 66 back into the body 70 after the water, pneumatic, or mechanical pressure has been terminated. In other words, the spring 74 is what causes the riser 66 to pop down after it has popped up during use. The riser 66 has a first end portion 76 and a second end portion 78. The first end portion 76 is what is caught by the cap 72 of the sprinkler head 44 to prevent the riser 66 from completely leaving the inside of the body 70. Please note that all of these items may be integrally formed from the beginning or they can be designed to assemble and disassemble later to allow riser 66 to be replaced. The second end portion is the top part of the riser 66 which will extend completely out of the ground upon actuation of the sprinkler head 44. In the illustrated embodiment, the riser 66 includes indicia 80 to locate the position of underground components of the irrigation system 20. It is contemplated, however, that other types of indicia 80 or markings can be used to identify the location of different underground system components. In fact, even indicia 80 that are integrated structures can be used. These different methods are referred to more in detail in FIGS. 7A-I. However, those skilled in the art will realize that even FIGS. 7A-I are not exhaustive of the different methods of marking or using indicia in order to locate the underground system components. The second end portion 78 of the riser 66 also includes a top surface 82 where indicia 68 can be located in some embodiments. The first end portion 76 of the riser 66 also has grooves 84.

Referring now to the body 70 of the sprinkler head 44, we see that the body 70 has a first end portion 86 and a second end portion 88. The second end portion 88 is constructed and arranged to receive the riser 66 through a recess 89 defined therein. The recess 89 is shown through a cut-out view of the body 70 in FIG. 3. It also illustrates that the body 70 has notches 90 that cooperate with the grooves 84 of the riser 66. The riser 66 is constructed and arranged to be received by the recess 89 and to non-rotatively slide up and down therein. The first end portion 86 may be constructed in a variety of manners that allow it to be connected to the pipes 52 and allow fluid to flow through into the body 70.

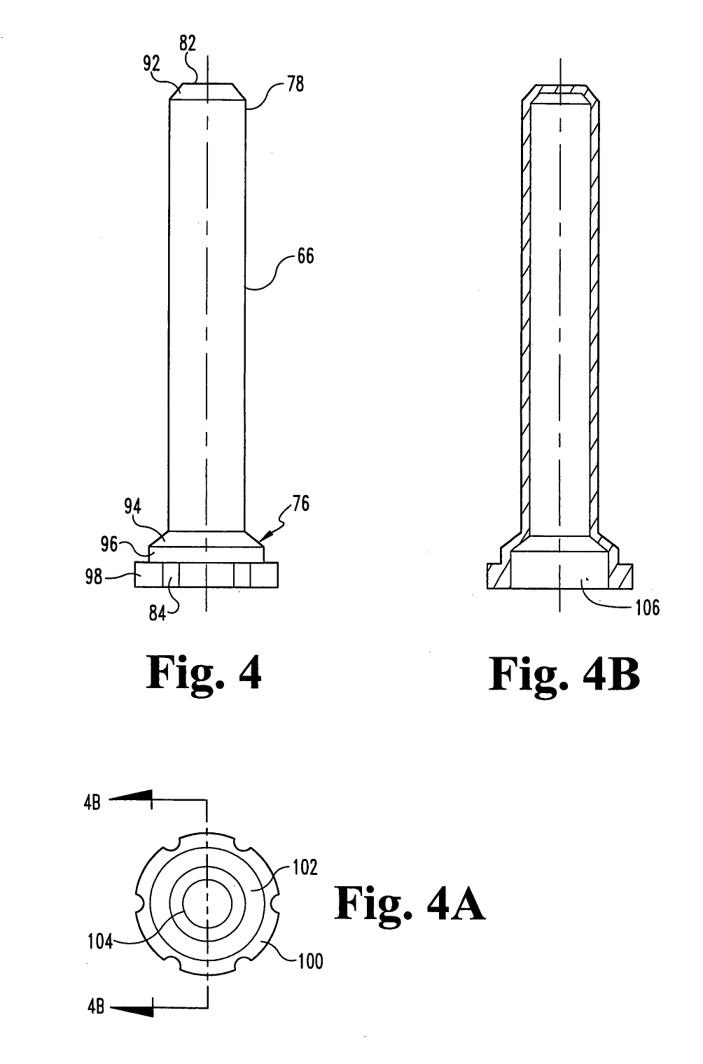

One embodiment of the riser 66 is illustrated in FIG. 4. A beveled section 92 exists at the second end portion 78 before it turns into the top surface 82. Furthermore, there is a second beveled section 94 on the first end portion 76 along with a first cylindrical portion 96 and a second cylindrical portion 98. This configuration is used to fully contact with the recess 89 of the body 70.

FIG. 4A illustrates a bottom view of the riser of FIG. 4 illustrating that there is a bottom surface 100 of the second cylindrical portion 98 and an inner surface 102 and a top surface 104 that is closed preventing any fluid from escaping enabling the pressure to build and cause the riser 66 to rise. FIG. 4B is a cross section of FIG. 4 through section 4B-4B indicated in FIG. 4A. FIG. 4B illustrates that there is an opening 106 in the first end portion 76 that allows the fluid to flow into the riser 66 in order to drive it upward.

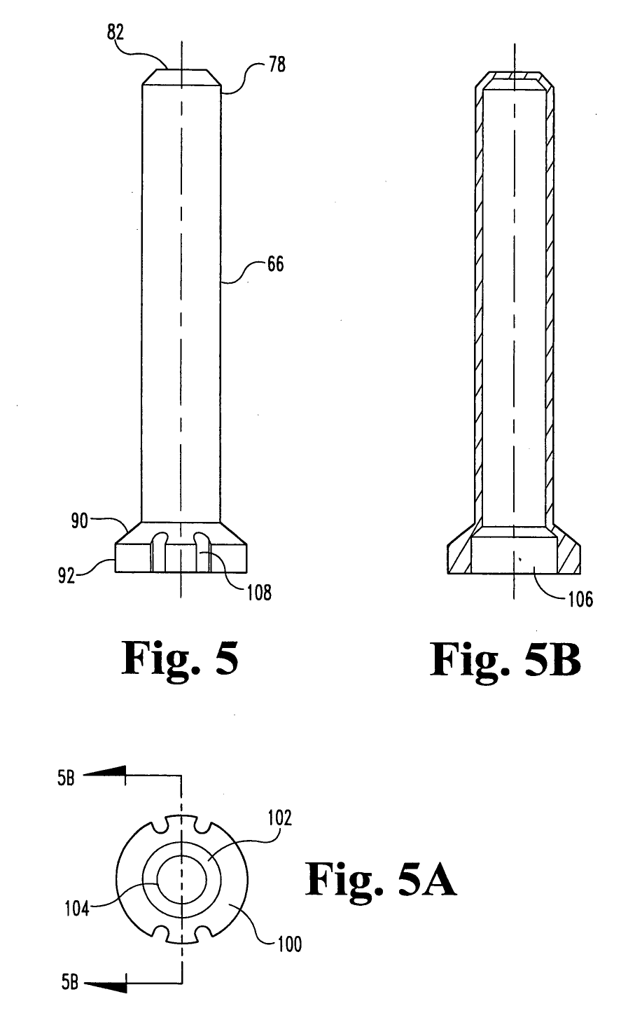

Referring now to FIGS. 5-5B, a similar riser 66 is illustrated except for the addition of long grooves 108. These grooves are used to cooperate with different makes and models of risers and sprinkler heads that exist in the industry. For example, some of the main industry leaders are Rain Bird, Toro, Hunter and other companies having different sprinkler head designs. Therefore, a variety of different groove and/or riser designs are contemplated to use with different systems manufactured by many different companies.

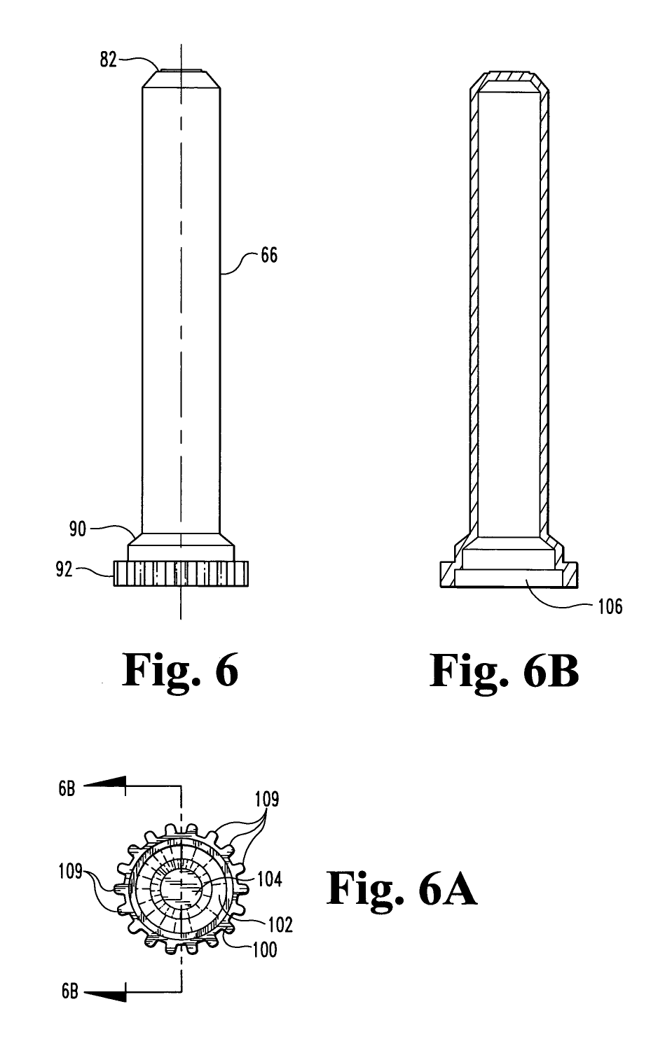

Referring now to FIGS. 6-6B, another similar riser 66 is illustrated. The riser 66 is of a more universal design for use with more than one type of sprinkler head. The riser 66 includes a plurality of flanges 109 to enable connection to a wide variety of different sprinkler heads. Therefore, while only three embodiments of the riser 66 are illustrated, those skilled in the art recognize that virtually unlimited groove patterns or other riser designs can be used in alternate embodiments.

In operation, the sprinkler head 44 operates as follows. Fluid from the supply system 22 flows through an open valve 38 and enters into a pipe 42 or the like that is operatively coupled to the first end portion 86 of the body 70. The riser 66 has been received by body 70 and is completely enclosed inside the body 70 so that only the very top surface 82 of the riser is visible from above ground. As fluid flows through the opening in the first end portion 86 of the body 70, it also flows through the opening 106 and inside the riser 66. The fluid continues to fill up the inside of the riser 66 until the fluid reaches the top inner surface 104 and covers all the inner surface 102 of the riser 66. At this point, pressure begins to build which causes the riser 66 to slide inside of body 70 and out above the ground. When the water pressure is sufficient, the riser 66 has completely popped up. As the riser rises, spring 74 becomes compressed creating stored potential energy for when the water pressure subsides. The riser 66 is caught by the second end portion of the body 70 to insure that it is kept inside and restrained by the body 70. The riser 66 contains indicia 80 or markings that point to or indicate the location of the underground system component that is desired to be located. Once the fluid pressure subsides, the potential energy in the spring 74 is released and the spring 74 expands causing the riser 66 to sink back down into the body 70 and out of sight.

FIGS. 7A-7I describe a few of the indicia 68 or markings that can be used in order to indicate the location of the underground system components desired to be located. Those skilled in the art, however, will recognize that a large variety of ways of orienting indicia 68 or markings exist and are contemplated to be used in alternate embodiments. FIG. 7A indicates indicia 68 which is just a single arrow. The single arrow could be used at the end of a pipe length showing that the pipe is running back along in the direction that it points.

FIG. 7B has an indicia 68 which is a double arrow. This could be used to indicate that there is pipe currently running underneath and extending out in both directions. Alternatively, it could be used to indicate that two valve boxes could be found on either side.

FIG. 7C is a L arrow design showing that the pipe has changed direction and runs in one way and makes a 90 degree in another way. The orientation of the indicia 68 of FIG. 7C could be rotated in any manner, shape or form to indicate various positions.

FIG. 7D is a T shape showing that one section of the pipe has ended and has separated out into a T moving in different directions.

FIG. 7E is a cross shape showing that is an intersection of two perpendicularly running pipes.

FIG. 7F is a 45 degree angle showing that the pipe is coming in and going out at a 45 degree angle. It is contemplated that the 45 degree angle could be used in combination with any of the indicia described in FIG. 7A-7E to add additional level of detail.

FIG. 7G is an indicia that has no specific degree requirement and the pipe is just running in these general directions. It is contemplated that these could be either used with other T designs or any other types of designs.

FIG. 7H has a marking 80 on the side of a cap or other top area of the riser 66. For example, these markings 80 could be on the side of the riser 66 in a square shape. Alternatively, they could be on the beveled section 92 as illustrated in FIG. 4 or they could just be blotches or shapes placed on the top surface 86. FIG. 7H generally illustrates that markings could be put anywhere around the top of the riser 66 in order to indicate that the location of an underground system component. The markings and indicia 68 can be stamped on, pasted on, labeled, injection molded, braised, welded on, die cut or formed with the riser in any manner presently known by those skilled in the art.

FIG. 7I shows an attachable cap 110 that includes an indicia 68 that could be used in alternate embodiments of the invention. While a cap 110 is illustrated, other embodiments contemplate other attachments to the riser that include an indicia. One example is the cap 74 that is used to screw over the riser 66 could be a screw on, a snap on, or other similar cap that contains the indicia 68. In addition, a cap 110 could be used that could attach to an existing riser 66 to cover up the nozzle to turn it into a locating spray head instead of a regular spray head. Alternatively, a screw on cap could be used with an average locating riser in order to allow the cap 110 to be changed to conform with changes that may be made to the location of the underground components in the sprinkler system. The cap 110 could be screw on, snap on, could be integrally formed therewith, or attached in any manner readily apparent to those skilled in the art.

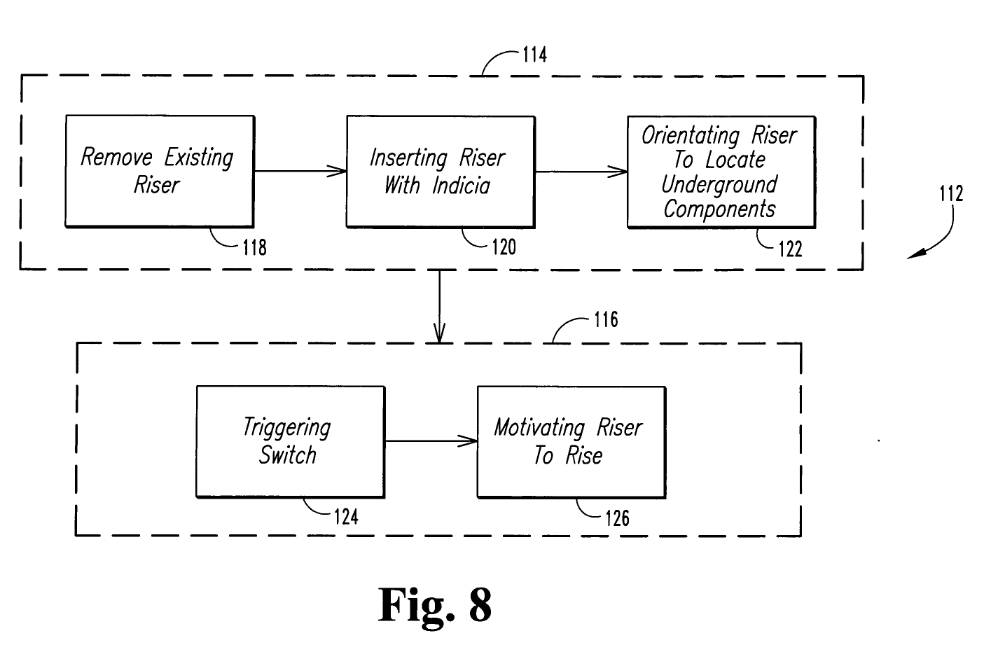

The indicia 68 carrying riser 66 is designed to either be originally built in before the irrigation 20 is designed or to retrofit to existing irrigation systems. FIG. 8 illustrates a method to update an existing irrigation system so that underground components of the system can be located using risers. The method 112 includes two main steps. The first step 114 is concerned with replacing the existing riser component of a sprinkler spray head with a riser having indicia for identifying the location of an underground system component. The second step is 116 and is concerned with actuating the sprinkler head riser so that it locates the underground system component.

The first step of replacing the existing riser component with a new riser component is broken into three smaller sub-steps is illustrated in FIG. 8. The first sub-step 118 is to remove the existing riser. Commonly this may be done by taking off the cap of the body and pulling out the riser inside. Other times it may need digging up the areas around the sprinkler spray head. Those skilled in the art of replacing risers will recognize that there are many different types of sprinkler spray head designs and correspondingly there are many different methods for removing the existing riser for each type of spray heads. The next sub-step 120 is to insert the riser having indicia or markings. As stated previously, a variety of types of riser designs can be used. The common factor is that the riser design will have an indicia located thereon or markings along the side or the top that indicate the location of the underground system components. The final sub-step 122 is to orientate the riser so that indicia or the markings properly locate the underground components. For instance, if the indicia shown in FIG. 7A were used, having an arrow pointing opposite from the direction where the pipe is located defeats the entire purpose of the locating indicia. Therefore, ensuring the riser is properly inserted and orientated is extremely important.

The actuating step 116 is composed of two smaller sub-steps. The first sub-step 124 is to trigger a switch or the like to actuate the locator valve so that the locating risers rise up. Of course, in other embodiments, this step is removed as the locating risers simply rise up with the rest of the sprinkler heads when fluid is applied. The triggering mechanism can be any mechanism commonly known to those skilled in the art such as a button or switch or the like. Step 116 then moves to the next sub-step 126 which is motivating the riser to rise 126. As discussed before, this can be done in a variety of ways. The riser can be motivated to rise by electromechanical methods such as flipping a switch causing an electrical signal to be sent to a motor or piston that is used to cause the riser to rise up. Alternatively, hydraulic means can be used where some type of fluid, such as those listed in the previous illustrated embodiments, is used to apply pressure to the riser to force it up out of the ground. In addition, in other embodiments, the force can be pneumatic because the fluid that is attempting to be sprayed is not liquid or that a separate line has been connected for the locating risers.

While selected embodiments have been illustrated and described in detail in the drawings and foregoing description, the same is to be considered as illustrative and not restrictive in character, it being understood that only a few embodiments have been shown and described. All contemplated embodiments are desired to be protected.

The inventions I claim are as follows:

1. A system to identify the location of one or more system components located under the ground comprising:
a rising structure including indicia, wherein said rising structure moves through a variety of substantially vertical positions relative to said ground, wherein said indicia indicates the location of one or more buried system components when said rising structure occupies at least one substantially vertical position.

2. The system of claim 1, further including a plurality of rising structures.

3. The system of claim 2, wherein said indicia on said rising structures comprises differing colors to indicate different types of said one or more buried system components.

4. A device for locating one ore more underground system components comprising:
a body operatively connected to said one or more underground system components, wherein said body defines a recess;
a riser constructed and arranged to be received by said recess defined by said body, wherein said riser includes indicia for identifying the location of said one or more underground system components; and
wherein actuating said riser results in said riser identifying the location of said one or more underground system components.

5. The device of claim 4, wherein said underground system is an irrigation system.

6. The device of claim 4, wherein said underground system is utility lines.

7. The device of claim 4, wherein said underground system is cable lines.

8. The device of claim 4, wherein said underground system includes data transmission lines.

9. The device of claim 4, wherein said body is a sprinkler head body.

10. The device of claim 4, wherein said riser is a sprinkler head riser.

11. The device of claim 4, wherein said body includes notches and said riser defines grooves, wherein said notches are constructed and arranged to insert into said grooves of said riser.

12. The device of claim 4, wherein said indicia are markings formed on the top of said riser.

13. The device of claim 4, wherein said indicia are markings along the side of said riser.

14. The device of claim 4, wherein said indicia are markings formed around the top of said riser.

15. The device of claim 4, said indicia further including a cap that contains the indicia.

16. The device of claim 15, said indicia further including a screw-on cap that contains the indicia.

17. The device of claim 15, said indicia further including a snap cap that contains the indicia.

18. The device of claim 10, wherein said riser includes a plurality of flanges.

19. A method for installing a riser to identify the location of one or more sprinkler system components comprising the steps of:
(a) replacing the riser component of a sprinkler spray head with a riser including indicia for identifying the location of one or more sprinkler system components; and
(b) actuating the riser to identify the location of the one or more sprinkler system components using the indicia.

20. The method of claim 19, step (a) further comprising:
(a1) removing the existing riser component of the sprinkler spray head; and
(a2) inserting the riser including indicia into the sprinkler spray head; and
(a3) orientating the riser to ensure that the indicia will locate the one or more sprinkler system components.

21. The method of claim 19, step (b) further comprising:
(b1) triggering a control switch; and
(b2) motivating said riser including indicia to move to a revealing position.

22. A system for locating one or more underground system components comprising:
a rising structure including indicia;
wherein the rising structure occupies a lower position and an upper position during operation, wherein the indicia is partially or totally hidden when the rising structure occupies the lower position, wherein the indicia is readily visible to locate one or more underground system components when the rising structure occupies the upper position.

23. The system of claim 22, further including a plurality of rising structures.

24. The system of claim 22, wherein the indicia on the rising structures comprises differing colors to indicate different types of said one or more system components located under the ground.
